(19) United States
(12) Patent Application Publication
(10) Pub. No.: US 2017/0086439 A1
(43) Pub. Date: Mar. 30, 2017

(54) Tieable Quick Release Fishing Sinker

(71) Applicant: Robert P. Bono, Oceanside, CA (US)

(72) Inventor: Robert P. Bono, Oceanside, CA (US)

(21) Appl. No.: 15/199,835

(22) Filed: Jun. 30, 2016

Related U.S. Application Data
(60) Provisional application No. 62/187,154, filed on Jun. 30, 2015.

(51) Int. Cl. A01K 95/02; A01K 95/00

(52) U.S. Cl. CPC A01K 95/02; A01K 95/005

(57) ABSTRACT

A quick release fishing sinker consists of a sealed packet formed from a material that dissolves in water, and weighted sinker material contained inside the sealed packet. The sealed packet may be composed of an elongated volume of dissolvable polymer film that has an unfilled portion formable into a tieable thread line for attachment by tying to fishing line, bait, or fishing tackle. The unfilled portion of the packet may occur between filled ends of the packet or primarily at one end of the packet opposite a filled end of the packet.

### CROSS-REFERENCE TO RELATED APPLICATIONS

This application claims priority to U.S. Provisional Application 62/187,154 filed on Jun. 30, 2015, which is fully incorporated herein by reference.

### BACKGROUND OF THE INVENTION

Field of the Invention

The present invention relates generally to fishing sinkers, and more particularly to releasable sinkers that detach from fishing line after contacting water.

Description of Related Art

The distance that a fisherman can achieve when casting line is conventionally increased by adding weight to the baited end of the line. This weight, commonly called a sinker, may be composed of any dense material, such as lead, and may be attached to the line in any of various ways. One way is by tying the sinker to the baited end using a separate leader. Another way is by attaching the sinker directly to the main line some distance behind the bait, for example, by threading the main line through a loop in the sinker and tying it off, or by compressing a specially formed sinker (known as split shot) directly onto the line. Another way to add weight to the baited end is by forming a fishing lure with integral weight, as is commonly done for spoons, spinners, and other fishing devices designed for deep water or bottom fishing.

While the added weight may improve casting distance, problems may arise after the bait hits the water. One problem is that the weight drags the bait to the bottom. This may not be desirable for certain techniques such as fly fishing, which are used to catch fish that feed near the surface. Another problem is that the weight can interfere with the action of a lure, or cause the line to become tangled during retrieval. Another problem is that dragging too much weight through the water can frighten the fish or otherwise discourage them from biting. But perhaps the biggest problem with loading up on weight is that it greatly increases the chance of snagging the line on the bottom during retrieval. This leaves the fisherman with the frustrating chore of having to cut the line and rig up a new baiting system, not to mention the loss of another hook, line, and sinker.

Fishing and the capture of fish and other water dwelling wildlife would be greatly improved by a sinker that can be added to the baited end of a fishing line and jettisoned after casting.

### SUMMARY OF THE INVENTION

A fishing sinker is composed of a packet filled with sand or gravel or other weighted material that is preferably organic or non-toxic to wildlife. The packet itself is composed of a material that dissolves in the presence of water, such as a polymer film. The packet may be generally rectangular in shape, and heat-sealed after filling its interior volume with the weighted material. The thickness of the polymer film may be selected to achieve a desired release time, which is the time required for the packet to detach from the line after immersion in water. The thickness of the polymer film is also selected for proper pull strength, that is, to ensure that the sinker can withstand a casting force without ripping away from the line prior to immersion. The area, number, and location of heat-seals my also be varied as desired to affect the dissolving rate and to withstand the casting force.

Fishing line may be attached at one end of the filled packet by various means, such as by impaling the packet with a fish hook below a heat seal, or by tying the fishing line through a hole defined in the line-attaching end, or by threading the fishing line through the hole. The line-attaching end may define a funnel-shaped, or fused portion of the polymer that is narrower that the width of the packet at the opposite end, to promote detachment of the sinker from the line at the fused portion. Optionally, a rapidly disintegrating water soluble paper material may be added as a strengthener or as a fuse at the line-attaching end. The paper may be partially enclosed within the polymer or may attach to an exterior part of the polymer in such a way that exposes the paper directly to water upon immersion of the sinker.

Other embodiments include forming the sinker as described above, but as an tieable quick release fishing sinker that comprises an elongated and narrow packet of dissolvable film that is filled at both ends and empty in the middle. The empty middle portion may then serve as a ribbon or thread line appendage which can be tied to the fishing line, bait, or another part of the fishing tackle. Another embodiment also forms the sinker as an elongated, narrow, packet of dissolvable film that is only partially filled at one end, to leave an adequate amount of unfilled volume that may then be tied to fishing line or another part of the bait or tackle without involving the fishing hook by forming a ribbon from the unfilled end.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. Dimensions shown are exemplary only. In the drawings, like reference numerals may designate like parts throughout the different views, wherein:

FIG. 1 is a sketch of the packet component of an embodiment of the invention showing a simple stabbing through of a fishing hook into and through the heat sealed portion of the packet.

FIG. 2 is a sketch of the packet component of an embodiment of the invention showing a simple stabbing through of a fishing hook into and through the non-heat-sealed portion of the packet, and showing a pulling of the packet up and over the hook eyelet so that the packet rests against the eyelet rather than resting at the dip of the hook as in FIG. 1.

FIG. 3 is a sketch of a fishing hook stabbed into and through one side of the packet component of the invention, and subsequently stabbed into the opposite side of the packet, such that the packet is threaded onto the fishing line and disposed so as to rest above the fishing hook.

FIG. 4 is a series of block diagrams showing heat sealing variations and geometry variations with respect to embodiments of the invention, which can improve usability of the invention under various restricting conditions.

FIG. 5 is a sketch of a typical configuration of the invention, including a packet component manufactured from a dissolvable polymer film material; a dissolving paper component which is shown attached to the packet; weighted sinker material which is contained inside the packet; and a small circular area is shown indicating generally where a fishing hook may be pushed through the packet.

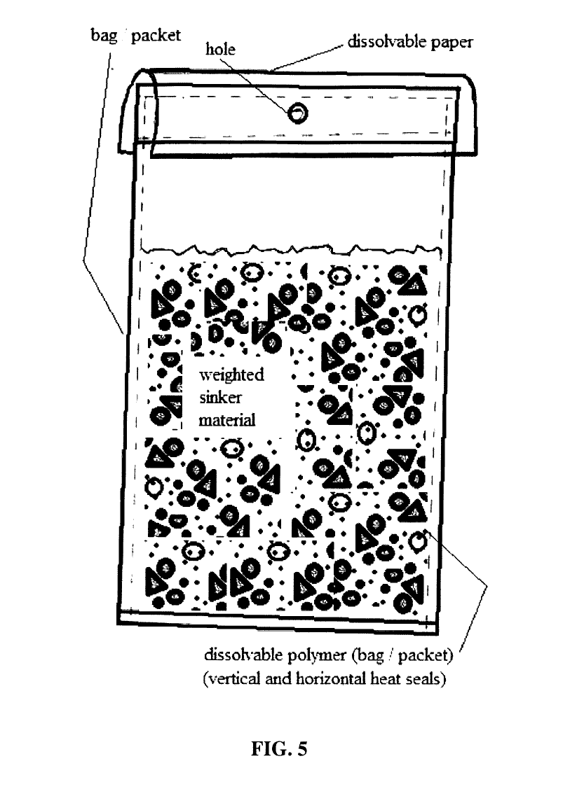

FIG. 6 is a sketch of an elongated narrow packet composed of sand and a dissolvable polymer film material, that has enough unpacked area to act as a ribbon or thread line appendage which may be attach to the line, bait, or another part of the fishing tackle, e.g., by tying.

FIG. 7 is a sketch illustrating how, with a simple knot, a partially filled, elongated, narrow dissolvable packet can be tied to the line in a manner which avoids altogether any involvement of the fishing hook.

### DETAILED DESCRIPTION OF THE INVENTION

This invention further clarifies use of dissolving film in detachable sinker design, and the formation of the film into dissolvable packets suitable for filling with weighted material such as sand, salt, fish oil, etc. Sand is the weight material of most interest due to its low cost, inertness, and non-toxicity. Other materials of interest include gravel, salt, sugar, and other grainy or dissolvable material.

Various types of non-aqueous liquids, such as oils, may be added to the weighted material. Some dissolvable packets may be formed from various sand and oil combinations including using fish oils and other wildlife attractants.

There are several ways to attach the invention to a fishing line or lure. Some attachment methods are better suited to particular types of fishing, types of fishing lures, types of hook, tackle, etc.

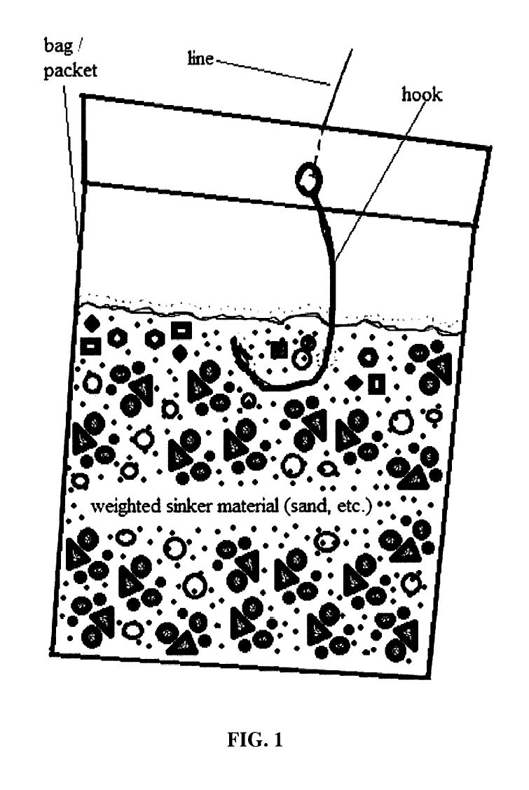

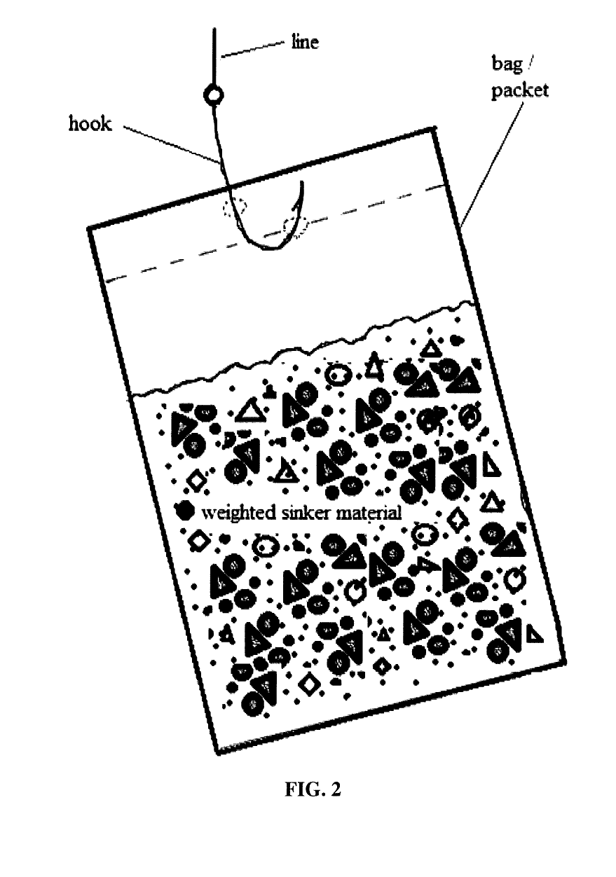

One attachment method is to simply stab the hook into the line-attaching end of the dissolvable packet in one of several places, for example above a heat-seal or in an area between two heat seals. Another attachment method involves stabbing the fishing hook into one of several places along the dissolvable packet and then pulling the packet up and over the eyelet of the top of the hook, so that the packet rests against the eyelet (see FIG. 2) rather than just resting at the dip of the hook as in FIG. 1.

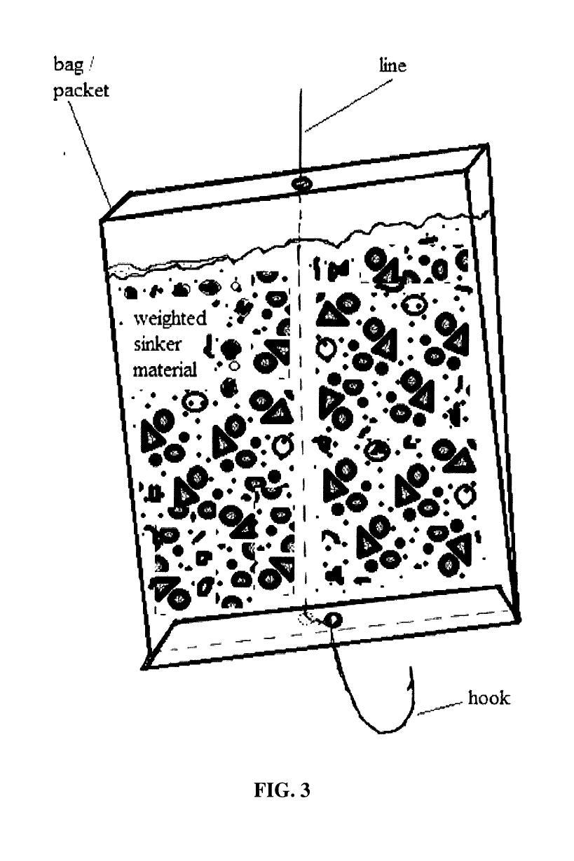

A third attachment method involves a stabbing through of a fishing hook into one side of the dissolvable packet, and subsequently stabbing the hook through the opposite side of the packet, to allow the packet to be threaded onto the line and thus allowed to rest above the hook eyelet completely (see FIG. 3). This method and some of its variations allows the packet to remain above the hook and thus free of potentially touching the live bait or other bait that would be placed above the hook. In some cases, this is a sure means of preventing the packet from getting prematurely wet (i.e. by the bait placed on the hook) and thus possibly prematurely separating from the line (i.e. before being cast out into the water) or perhaps prematurely opening the packet surface area and prematurely releasing sand or oil from the packet.

In another embodiment, rapidly disintegrating water soluble paper (or simply a “dissolving paper”) can be used in place of the dissolving film in one of several places on the dissolvable packet. For example, the entire packet could be made of dissolving paper. Unlike with dissolving film, however, when dissolving paper comes in contact with oil, its dissolving properties change. Therefore, a dissolving paper material may be added as a strengthener or as a fuse at the line-attaching end. The paper may be enclosed within the polymer or may attach to an exterior part of the polymer in such a way that exposes the paper directly to water upon immersion of the sinker. The thickness and area of the dissolving paper fuse portion may be selected to determine the dissolving rate.

The film can be sealed so that the packet is of a desired geometry to assist usability, such as shaping the packet to provide for different release times, different casting strengths, and other variable parameters. Simple heat-sealing methods used to manufacture typical packets of salt, sugar, etc. are known to work well.

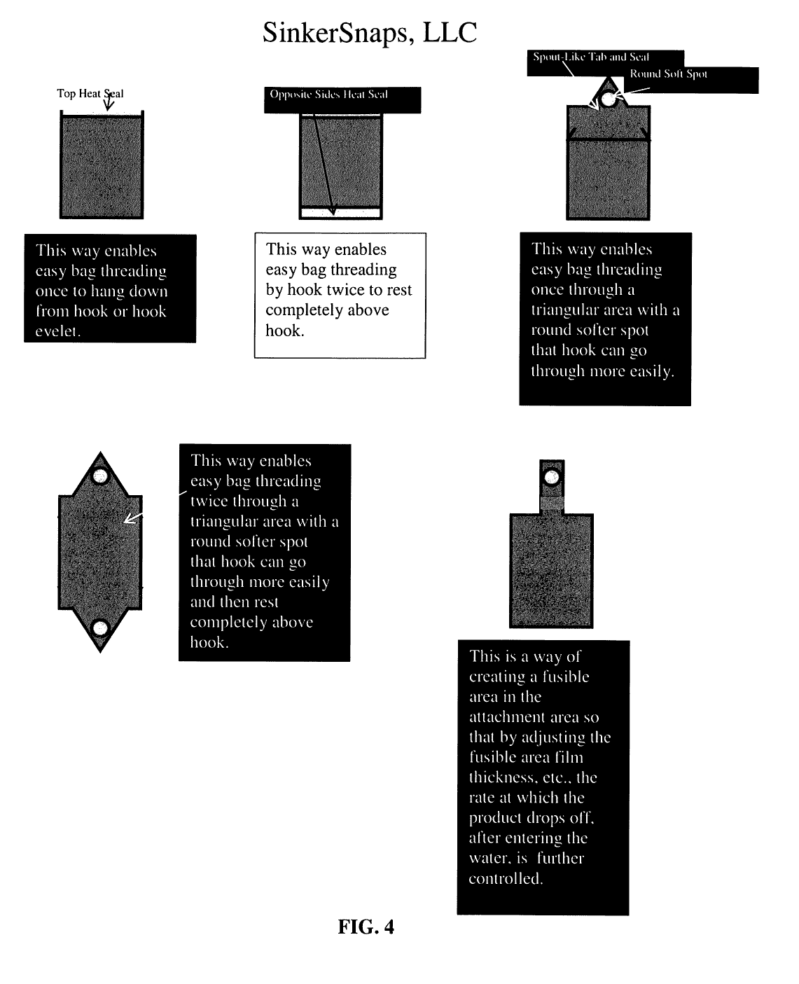

Some specialized sealing methods used by packet manufacturers are also well suited to creation of the packet. For example, a packet can be formed that has a funnel-type end such as those commonly used to dispense ketchup, mustard, etc. Such an end can be used to enable the narrow part of the funnel to become a specialized attachment and fusing mechanism for the invention. FIG. 4 shows various ways in which heat sealing variations and geometry variations can be used with respect to the shape of the invention.

The dissolvable packet may be formed from a polymer film such as polyvinyl alcohol (PVA), polylactide (PLA), or polyglycolide (PGA). Various film thicknesses may be used to achieve a desired tensile strength or dissolving rate or release time. The dissolvable packet may be formed from two layers of polymer film by heat-sealing the layers together vertically and horizontally to form three sealed sides and an open top. These seals create the volume for retaining the weighted material within the interior of the packet. After filling the packet from the open top, the top is also heat sealed. In one embodiment, the open top end, after sealing, becomes the line attaching end. The top end may be configured with multiple heat seals to form an area for attaching fishing line, for example, an area between two horizontal seals. A hole may be formed through this area between the seals, for tying or threading of fishing line.

In one exemplary embodiment, a sinker weighing approximately one ounce is formed by heat sealing polymer layers into a rectangular packet measuring 2 inches long by ¾ inches wide by ¾ inches thick, filling the packet with sand, and sealing the top of the packet. The top of the packet is preferably sealed by a heat-weld.

In other embodiments, a strip of dissolving paper may be placed in or around the line attaching end of the sinker to increase the pull strength of the packet. Some or all of the dissolving paper attached to this area is exposed on an exterior surface of the packet. The paper may be partially enclosed within the polymer or may attach to an exterior part of the polymer in such a way that exposes the paper directly to water upon immersion of the sinker. This exposed portion of the dissolving paper acts like a mechanical fuse, in that the dissolving paper is selected to dissolve more rapidly than the polymer and therefore determines the release time required for the sinker to detach from the fishing line. The fuse portion may be formed in a variety of shapes to achieve a desired release time.

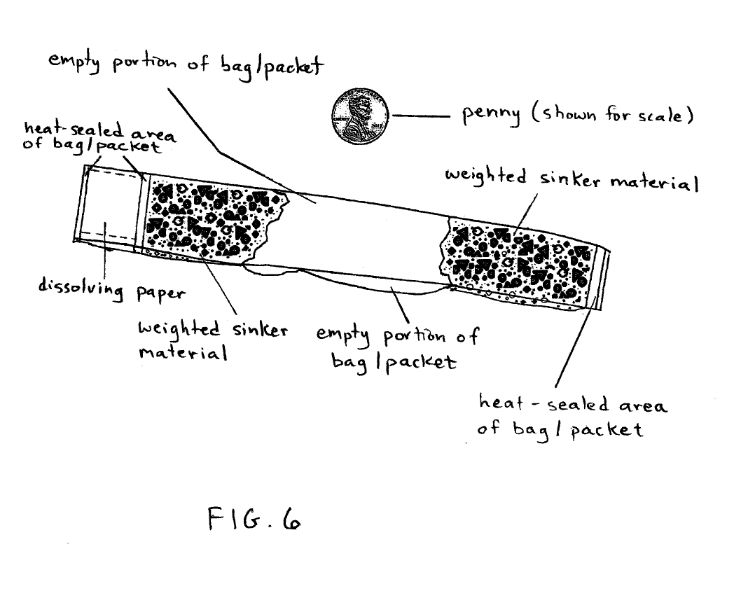

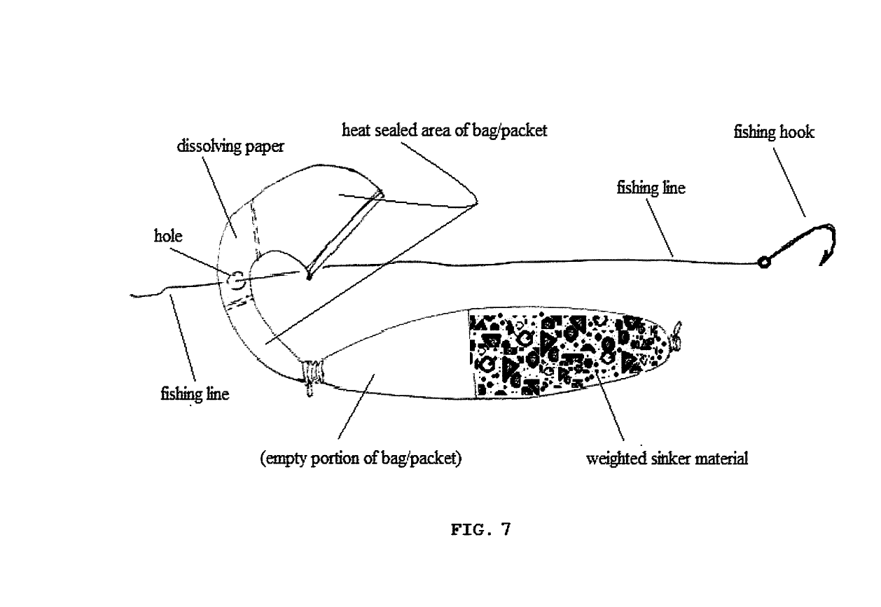

In other embodiments, as shown in FIGS. 6 and 7, a packet may be formed from an elongated and narrow volume of dissolvable polymer film material that is partially filled with a weight such as sand or gravel but that has enough unfilled volume to act as a ribbon or thread line appendage. Elongated as used herein means that the length of the packet is at least twice that of the diameter or width. In one embodiment, an elongated packet according to the invention has a length four times its diameter or width. This unfilled portion of the volume may be tied or looped directly to the fishing line, bait, or other part of the fishing tackle, or the fishing line may be tied around the unfilled ribbon area. Or, the line may be threaded through a hole formed in the unfilled portion, as shown. In one embodiment, the material characteristics of the packet are such that the unfilled portion of the packet may comprise, or may be twisted to form, a tieable ribbon or line having a diameter suitable for tying to a fishing line using, for example, a half hitch knot or two half-hitches. In one embodiment, the packet is configured such that the diameter of the unfilled portion when twisted into a tieable ribbon is between about 1/16 and 3/16 inches. The unfilled portion of the elongated volume may occur between filled ends of the packet, as shown in FIG. 6, or it may occur primarily at one end of the packet opposite a filled end of the packet, as shown in FIG. 7.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A sinker comprising:
a sealed packet formed from a material that dissolves in water; and
weighted sinker material contained inside the sealed packet.

2. The sinker of claim 1 wherein the sealed packet is composed of a dissolvable polymer film.

3. The sinker of claim 2 wherein the dissolvable polymer film is selected from the group consisting of polyvinyl alcohol (PVA), polylactide (PLA), and polyglycolide (PGA).

4. The sinker of claim 2 wherein the sealed packet is formed by heat sealing the dissolvable polymer film.

5. The sinker of claim 1 wherein the weighted sinker material consists of one or more substances selected from the group consisting of sand, salt, and sugar.

6. The sinker of claim 1 wherein the sealed packet is at least partially composed of a dissolvable paper.

7. The sinker of claim 1 wherein a portion of the sealed packet is composed of a dissolvable polymer film and another portion of the sealed packet is composed of a dissolvable paper.

8. The sinker of claim 7 wherein the sealed packet has a generally rectangular shape and the dissolvable polymer film is heat sealed vertically along each of the left and right sides of the packet and heat sealed horizontally along each of the upper and lower sides of the packet.

9. The sinker of claim 8 wherein the heat sealed portion of the upper side of the packet consists of two horizontally disposed flaps each of which are heat sealed to each other and to the packet.

10. The sinker of claim 8 wherein the heat sealed portion of the upper side of the packet extends to form a triangular spout-like tab and seal surrounding a round softer spot optimized for hook piercing.

11. The sinker of claim 8 wherein each of the heat sealed portions of the upper side and lower side of the packet extends to form a triangular spout-like tab and seal surrounding a round softer spot optimized for hook piercing.

12. The sinker of claim 8 wherein a portion of the heat sealed portion of the upper side of the packet comprises a fuse that determines the release time of the sinker.

13. The sinker of claim 1 wherein the sealed packet is formed of sand and dissolvable polymer film material that has an unfilled portion formable as a tieable thread line for tying to fishing line, bait, or fishing tackle.

14. The sinker of claim 13 wherein the dissolvable packet is narrow and elongated.

15. The sinker of claim 13 wherein the unfilled portion of the packet occurs between filled ends of the packet.

16. The sinker of claim 13 wherein the unfilled portion of the packet occurs primarily at one end of the packet opposite a filled end of the packet.
